(19) United States
(12) Patent Application Publication
(10) Pub. No.: US 2003/0208423 A1
(43) Pub. Date: Nov. 6, 2003

(54) Method of fundraising

(75) Inventors: Michael Shotey, Scottsdale, AZ (US); Marcus Shotey, Scottsdale, AZ (US); George Lynn Hagen, Flagstaff, AZ (US)

Correspondence Address: Niro, Scavone, Haller & Niro, Suite 4600, 181 W. Madison, Chicago, IL, 60602, US

(73) Assignee: TayMac Corporation

(21) Appl. No.: 10/137,558

(22) Filed: May 2, 2002

(51) Int. Cl. G06F 17/60

(52) U.S. Cl. 705/35

(57) ABSTRACT

The present invention concerns a method and device which uses a computer system for raising and managing contributions. The system is designed to first issue a solicitation seeking contributions to prospective contributors. When funds are received they are agregated. Next, the system is designed to invest the contributions to generate income. The income generated is provided to the cause. Upon some predetermined refund trigger, the contribution is returned to contributor.

### BACKGROUND OF THE INVENTION

The present invention relates to a device and method of raising and managing contributions for causes requiring funding. More specifically, the present invention concerns raising funds through the coordinated use of solicitations, aggregating the funds received in an income producing vehicle, using the income generated for the cause, and eventually returning the funds to the contributor, if desired.

### SUMMARY OF THE INVENTION

To advance a cause requiring funding such as a non-profit organization, such as a theater, political agenda, political campaign cause, or even a charity, large sums of money often needed to be raised and managed. The most common method of financing used to date is to solicit contributions. This is often a difficult, expensive and time-consuming task. Equally important, the efforts are often unsuccessful due to a lack of trust and the fact that the contributions are nonrefundable.

The present invention overcomes many of the problems associated with fund-raising. It provides a computer based system that efficiently solicits, collects, and manages fund-raising. Equally important, the present invention increases the trust between the parties, and overcomes the inherent hesitation to contribute by making the act of funding relatively risk free. The present invention accomplishes this by investing the funds received into an income generating asset or account. The income earned is provided to the cause. A unique aspect of the invention is that the funds or a portion of funds may be returned to the donor at a later date. Thus, the present invention has the potential to raise large sums of money at little cost.

### DESCRIPTION OF THE DRAWINGS

These and other features, objects and advantages of the present invention will become apparent from the following description and drawings wherein like reference numerals represent like elements in several views, and in which:

FIG. 1 is an operational flow chart of one embodiment of the invention.

### DESCRIPTION OF THE PREFERRED EMBODIMENTS

Set forth below is a description of what are currently believed to be the preferred embodiments or best examples of the invention claimed. Future and present alternatives and modifications to the preferred embodiments are contemplated. Any alternates or modifications in which insubstantial changes in function, in purpose, in structure or in result are intended to be covered by the claims of this patent.

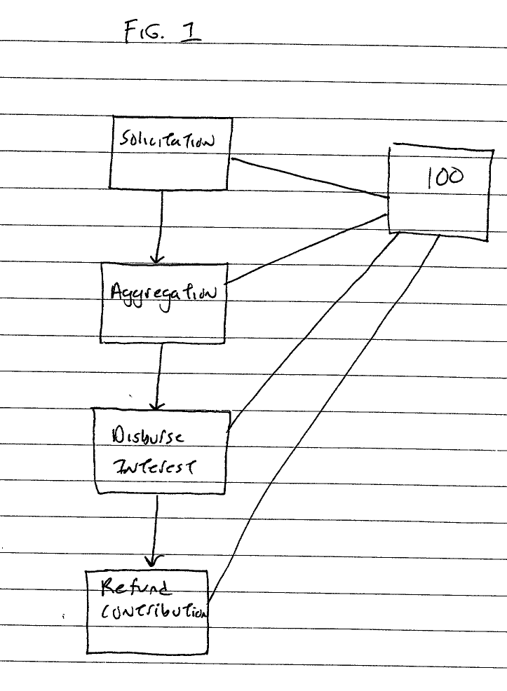

Referring to FIG. 1, the present invention operates as follows:

Step 1 Issuing a Solicitation:

The first step of the method involves issuing solicitations to potential contributors. In a preferred embodiment, this may be done by a computer system 100 that uses the internet. However, more traditional methods such as print-ads, radio, direct mail and television may also be used. In addition, a pay-per-view event may be used to generate contributions. The solicitation may contain salient information to be evaluated by the potential contributor. In addition, the solicitation may be focused on a particular issue of interest to the donor. The solicitation may also provide information as to the unique use that will be made of the contribution through the refundable nature of the contribution. Lastly, the solicitation would provide the potential contributor with the necessary information for making a contribution.

Step 2 Aggregating the Funds Received:

Contributions may be received in a wide variety of forms such as a check, electronic fund transfer or credit card payment. With each contribution received, customary information such as the contributor's name, contact information, and the like would be obtained. It is contemplated that this information may be stored in computer system 100 on a database.

As the funds are received, they are aggregated and invested in an investment vehicle that generates income. In one embodiment, the investment vehicle may be an income producing instrument. Such instruments may include T-Bills, government bonds, zero coupon bonds, preferred shares of stock, stock, mutual funds, derivatives and the like. In addition, the aggregated fluids may be invested in other assets as well. Such assets may include real estate, a business, or tangible objects. A trustee may be assigned to manage the funds.

To assist in the effective management of the fund, in addition to obtaining the donor's contact information, an account or identification number or code may be assigned to each donor and stored on the computer system's database. Once the donor information is processed, a receipt or confirmation may be issued electronically over the internet by the computer system 100 and in other ways known to those of skill in the art. The receipt may include data such as the amount of the contribution, the donor information, and, as set forth below, an indication as to the type of refund trigger that is to be used.

Step 3 Disbursing the Income:

As the aggregated funds generate or earn income, the income is disbursed to the cause identified by the donor. Periodic statements may be issued by the Trustee or others associated with the cause via the internet by the computer system 100 and in other ways known to those of skill in the art. Such reports may track the progress being made by the cause, provide summaries as to the total contributions raised, and may also contain other information to maintain interest in the cause.

Step 4 Disbursing the Contribution:

As mentioned above, a unique aspect of the invention is that the contribution may be fully or partially refunded. The refund may be triggered by a number of different events.

A first trigger may be the termination of the cause. A second trigger may be a predetermined time period such as one year. Another trigger may be at the request of the donor by giving notice to the Trustee or some other entity.

To increase the appeal and ease of contributing to the cause, the donor may be given the flexibility to choose from a wide variety of refund trigger options. Having the ability to determine or control when the money is to be returned increases the comfort level of the donor and the trust between the parties.

The type of refund trigger to be used may be stored in the computer system's database. The computer system would be programmed to handle the refunds in a number of different ways. It may first send a notice of refund to the donor to confirm that a refund is desired and to verify any information needed to complete the transaction. The system may also be programmed to automatically refund the contribution.

In another embodiment, the solicitation sent by the computer system to a prospective donor may contain a loan agreement. When the loan is received, the computer system will issue a call to the contributor. The call sets forth the manner in which the loan or a portion thereof will be repaid by the cause. The refund triggers described above may be used by the computer system to set when the call becomes effective.

While the preferred embodiments of the present invention have been illustrated and described, it will be understood by those of ordinary skill in the art that changes and other modifications can be made without departing from the invention in its broader aspects. Various features of the present invention are set forth in the following claims.

What is claimed is:

1. A method using a computer system for raising and managing contributions for a cause comprising the steps of:
issuing a solicitation seeking contributions to prospective contributors;
aggregating contributions received;
investing said contributions to generate income;
providing said income to the cause; and
returning said contribution to the contributor upon a refund trigger event.

2. The method of claim 1 wherein said solicitation is issued electronically via the internet.

3. The method of claim 1 wherein said solicitation is issued via direct mail.

4. The method of claim 1 further including providing the contributor with an electronic confirmation of the receipt of said contribution.

5. The method of claim 1 further including providing the contributor with periodic updates via the internet.

6. The method of claim 1 wherein additional contributions are raised by pay-per view events.

7. A method using a computer system for raising and managing contributions for a cause comprising:
forwarding a solicitation seeking contributions to prospective contributors;
establishing a managed trust account for aggregating contributions received;
investing said contributions to earn income;
providing said income to the cause; and
returning said contribution to the contributor after a predetermined period of time.

8. The method of claim 7 wherein said solicitation is issued via the internet.

9. The method of claim 7 wherein said solicitation is issued via direct mail.

10. The method of claim 7 further including providing the contributor with a confirmation of the receipt of said contribution.

11. The method of claim 7 further including providing the contributor with periodic updates.

12. The method of claim 7 wherein additional contributions are raised by pay-per view events.

13. The method of claim 7 wherein said contribution is returned to the contributor upon notice from the contributor.
